(19) United States
(12) Patent Application Publication
(10) Pub. No.: US 2013/0099029 A1
(43) Pub. Date: Apr. 25, 2013

(54) PROCESS FOR PREPARING A THERMOPLASTIC POLYMER MIXTURE BASED ON AGAVE FIBERS AND RESIDUES AND OXO-DEGRADATION ADDITIVES FOR PREPARING BIODEGRADABLE PLASTIC ARTICLES

(71) Applicant: Soluciones Bioagradables de Mexico, S.A. de C.V, San Pedro Garza Garcia (MX)

(72) Inventors: Ana Elena Laborde Aguirre, Saltillo (MX); Jesus Angel Valencia Gallegos, Saltillo (MX); Juan Sergio Hernandez Valdez, Saltillo (MX); Jose Ignacio Del Real Laborde, Saltillo (MX); Manuel de Jesus Salvador Laborde Cancino, Saltillo (MX)

(73) Assignee: SOLUCIONES BIOAGRADABLES DE MEXICO, S.A. DE C.V, San Pedro Garza Garcia (MX)

(21) Appl. No.: 13/711,400

(22) Filed: Dec. 11, 2012

Related U.S. Application Data
(63) Continuation of application No. PCT/MX2011/000069, filed on Jun. 2, 2011.

(30) Foreign Application Priority Data
Jun. 11, 2010 (MX) MX/A/2010/006431

(51) Int. Cl. B02C 23/08

(52) U.S. Cl. CPC B02C 23/08
USPC 241/24.1; 524/9

(57) ABSTRACT

The instant invention relates to the plastic industry and more particularly to the biodegradable plastic industry. It consists of a conditioning process for Weber's Blue agave (agave) fibers and residues in combination with oxo-degradation additives for preparing a Masterbatch for use in the production of biodegradable plastic articles having outstanding characteristics of biodegradability and conservation of the physical properties of the objects made with said masterbatch.

### CROSS-REFERENCE TO RELATED APPLICATIONS

This application is a continuation of co-pending International Application No. PCT/MX2011/000069, filed Jun. 2, 2011, which designated the United States and was not published in English, and which claims priority to Mexican Application No. MX/a/2010/006431, filed Jun. 11, 2010, both of which applications are incorporated herein by reference.

### TECHNICAL FIELD

The present disclosure relates, in some embodiments, to the plastic industry, and more particularly to the biodegradable plastic industry. It includes processes for preparing a mixture comprising: thermoplastic polymers; Weber's Blue Agave (agave) fibers and residues; oxo-degradation agents as well as other additives for preparing biodegradable plastics.

### BACKGROUND

The use of thermoplastic polymers derived from non renewable hydrocarbons sources for the making of a large quantity of common articles and utensils, such as packaging, bags, plates, glasses, knives, forks, spoons, trays, medical articles such as implants, pipes, gloves, toys and the like—is an activity showing a high degree of technical maturity. It is widely diversified and distributed throughout the world owing to its processing ease, physical chemical properties and low cost. Several types of polymers derived from the mentioned non renewable hydrocarbon sources, such as oil and natural gas, can be used. It is also known that because of their widespread diversification, said materials show collateral environmental contamination problems once their useful life has elapsed owing to their growing accumulation and to the fact that, because of their chemical nature, their degradation through environmental factors can take hundreds of years. These problems have been widely documented and must be solved through alternatives solutions taking advantage of all the technical options to reduce or eliminate the current problems related to their processing and use. One of the developed alternatives is to obtain polymers from renewable sources such as, for example, crops that can supply, through chemical processes, the initial substances for their production. Another alternative is to substitute said materials by the so called biodegradable plastics such as the ones based on lactic acid, for example. However, these materials do not meet the high and growing quality and quantity requirements, and thus do not currently offer a real solution. Another option that has been contemplated is the modification of polymer formulation to lower the impact of their accumulation on the environment, making them susceptible to environmental factors such as: sun radiation, temperature, humidity, and microbiological activity. As a result of technical development, there exist plastics having various degradation characteristics. Among them the following ones can be mentioned:

Oxo-degradable materials: they refer to materials in which an additive that breaks large molecules links is introduced in the process of plastic transformation reducing thus the strength of said materials. They eventually become a nutrient source for microorganisms that end up degrading the plastic generating water, carbon dioxide and reusable biomass. This process requires oxygen and thus does not occur in anaerobic conditions. The degradation process can be adapted to 2-3 year periods, which is appropriate for the needs of the final user of a product such as plastic bags. However, the precise control of the property loss ratio is a worrying aspect for the users of the thermoplastic materials formulated with such additives because, once the degradation process has started, property loss can be very fast and make the material unusable before its contemplated application, causing important economic losses.

Biodegradable materials: they refer to materials in which the degradation is caused by microorganisms present in the natural environment. Typically, said plastics are based on starch or poly(lactic acid) polymers or copolymers (PLA) and are expensive to manufacture. The products manufactured with said material degrade in low- or no-oxygen conditions and emit methane gas (a gas 20 times more damaging for the environment than carbon dioxide), without leaving useful biomass residues. The end result is the contribution to factors identified as environmental hazards, such as the increase of environmental carbon dioxide and land pollution.

Compostable materials: these materials are plastics that degrade in a period of time similar to the known organic compounds, such as leaves and grass. The guidelines for products of these characteristics are defined in ASTM 6400 standard. Said conditions require a fast degradation period that can be reached by PLA and oxo-degradable plastics.

Particularly, the oxo-degradation process on hydrocarbon plastics, such as polyethylene (PE) and polypropylene (PP) consists of two stages, starting with the oxo-degradation additive that acts on the large hydrocarbon chains to accelerate the natural degradation process. It is known in the state of the art that in absence of this type of additives, said process can last hundreds of years. What occurs upon mixing the oxo-degradation additive with hydrocarbon plastics is the breaking of the chains forming the polymer reducing its molecular weight and making the molecules shorter and chemically susceptible to develop and promote the growth on their surface of a biolayer that is useful for supporting the development of microorganisms that in the end will degrade plastic into water, carbon dioxide and reusable biomass. It has been determined that by breaking large polymer chains into polymer chains of molecular weights lower than 10 kilodaltons (KDa) and having a carbonyl index greater than 0.1, the material is susceptible to start biodegrading. This process is not toxic and 100% safe for direct contact with food. If oxygen is not present, the polymer chains do not degrade which is an advantage compared to other biodegradable alternatives that continue their degradation process without oxygen and emit methane gas.

Use of Oxo-Degradation Additives

Oxo-degradation additives are known in the state of the art. Said additives are combinations of metal carboxilate and an aliphatic poly hydroxy carboxylic acid, such as described in U.S. Pat. Nos. 5,565,503 and 5,854,304 and described hereinafter illustratively. The preferred metal carboxilates are cobalt, cerium and iron stearates, although other appropriate carboxylates contain aluminum, antimony, barium, bismuth, cadmium, chromium, copper, gallium, lanthanum, lead, lithium, magnesium, mercury, molybdenum, nickel, potassium, rare earths, silver, sodium, strontium, tin, tungsten, vanadium, yttrium, zinc or zirconium. Aliphatic poly hydroxy carboxylic acid refers to an aliphatic acid having one or various hydroxyl groups and one or various carboxyl groups. Examples are aliphatic dihydroxy carboxylic acid, such as glyoxylic and glyceric acids, poly hydroxyl monocarboxylic acids such as erythric, arabic or mannitic acid, mono hydroxy poly carboxylic acids, such as malic acid, and dihydroxy dicarboxylic acids, such as tartaric acid. Additionally, said additives can include calcium oxide and other appropriate additives. Some of the commercial trademarks of the oxo-degradation additives described in the above paragraph are: Envirocare® sold by Ciba Specialty Chemicals, under license of EPI Environmental Technologies. Another additive known in the art is Addiflex® of Add-X Biotech AB, ca Swedish company. The company EPI Environmental Technologies markets additives of this type under the name TDPA®. Another oxo-degradation additive known in the art is Celspan® sold by Phoenix Plastics, United States of America, and is particularly preferred in some embodiments of the present disclosure. However, the use of said additives entails some misgivings regarding the degradation speed that can be obtained under different environmental conditions, because once the process has started, the property loss of the plastic articles accelerates.

Patent application WO 2006/135498 divulges a formulation for preparing degradable film to cover crops and generate a greenhouse effect in the covered area. Degradation is caused by ultraviolet radiation and temperature and its purpose is to improve the control of the film degradation properties through the use of an oxo-degradation additive.

Application WO 2009/087425 describes the manufacture of perfumed trash bags containing oxo-degradation additives and antibacterial agents conferring onto them degradability and a better control of the bacteria population growing in trash. However, they only use the oxo-degradation additive as degradation promoter. Thus, it is desirable to have a better system for promoting and controlling plastic product degradation.

Weber's Blue Agave

Weber's Blue Agave (Kingdom Plantae, Division Anthophyta, Class Monocotiledonae, Order Liliales, family Agavaceae, Subfamily Agavoideae, Gender Agave, Subgender Agave, Section Rigidae, Species Weber) is one of the 136 Agave species known and is widely distributed in several parts of the world. Particularly, it is widely cultivated in the tequila zone of western Mexico, including the states of Jalisco, Nayarit, Guanajuato and Michoacan, as well as in one zone of the state of Tamaulipas, and is used for preparing Tequila. The denomination of origin: “Tequila” refers to the alcoholic beverages obtained through the fermentation and distillation of 51% contents of blue agave produced in the mentioned geographical zone, according to the provisions of the NOM-006-SCFI-2005 Mexican Official Standard. For preparing Tequila, the agave long and pointed leaves are cut, leaving what is known as “pineapple”. Said “pineapple” is cut in segments of a given size that are cooked and squeezed out through appropriate mechanisms to extract a sugar rich fluid that is the basis of tequila. As a result of the tequila making process, by-products such as dregs or liquid effluents and agave bagasse fibers as solid effluent are obtained. Both liquid effluents and solid effluents generate an environmental problem because their accumulation. One of the most abundant residues is agave fiber estimated at over 200,000 tons per year and essentially sent to landfills or used as fuel. Agave fiber consists typically of 65% cellulose, 5.5% hemicellulose, 17 lignin and 12.5% extractable substances, as reported in Ifliguez-Covarrubias, G. Dias-Teres, R., Sanjuan-Dueñas, R., Anzaldo-Hernández and Rowell, R. M. Utilization of by-products from tequila industry. Part 2: potential value of Agave Tequilana Weber azul leaves. Bioresource Technology, 77, 101-108, 2001. This fiber can be reduced through physical means to various lengths and can be chemically degraded resulting in polymer molecules having various molecular weights susceptible of being used. For instance US patent application 2006/0222719 describes the manufacture of articles made of agave residues and thermofixed polymers in which the fiber plays an active reinforcement role, chemically reacting for incorporating itself into the infusible polymer mass, but its biodegradability characteristics are not used to improve material recycling.

Ian Bates, in document GB 2460215, refers to a laminated material for compostable packaging comprising a natural fiber web and a layer comprising latex or a latex derivative. The base layer comprises starch or cellulose derivative such as lactic or polylactic acid derivative or corn or starch derived biopolymer.

Nevertheless, Bates does not include the use of blue agave to supply fibers, individually or in various lengths, nor superficially treated maintaining their biodegradability and compostability capacity. Moreover, Bates does not consider the thermoplastic polymers mentioned in the present disclosure as part of the material. Jefter Fernandes Nascimento in publication US 2010/0048767 describes an environmentally degradable polymer mixture and a process for obtaining it. However, in said mixture, specific polymers are used such as polyhydroxybutyrate and polybutylene adipate/butylene terephtalate. However, the additive is a plasticizer, and not a biodegradability enhancer.

Lawrence T. Drzal, in U.S. Pat. No. 7,576,147, describes the preparation of cellulosic biomass with soy and vinyl-type polymers polymerizing in situ in materials for building structures, but does not include the thermoplastic polymers mentioned in the present disclosure.

Per Just Andersen, in U.S. Pat. No. 6,030,637, describes the use of natural and synthetic polymers in the preparation of paper, cardboard and packaging materials and although polymers are used, they are only used in the form of defined material layers, and their object is different from the object of the present disclosure because the creation of a polymer based biodegradable product is not contemplated.

Anil N. Netravali, in US publication 2008/0090939, describes soy-based biodegradable proteic compositions. However, it relates to compounds for preparing compositions based on biodegradable polymers and clays as well as an additive; but the object of said additive is not to enhance the biodegradation of the compound, but to strengthen the composition.

Stephen J. Faenher, in US publication 2009/0118396, describes a process for making thermoplastic and thermofixed compounds wherein natural fibers such as bagasse, sisal and other types of cellulosic materials are mixed with the thermoplastic or thermofixed compounds in order to improve the process, which is not an object of the present disclosure. Moreover, said publication includes neither an oxo-degradation additive, nor agave, nor mixtures thereof, but only sisal and other natural fibers.

It is obvious that none of the documents of the state of the art considers the combined use of oxo-degradation additives and agave fibers.

### SUMMARY

The present disclosure relates, in some embodiments, to a process for preparing a biodegradable polymers mixture.

According to some embodiments, the present disclosure relates to controlling process characteristics for obtaining a product that does not degrade abruptly, with the consequent loss of physical properties (resulting in economic losses), nor in many years, causing environmental contamination because of accumulation.

The present disclosure relates, in some embodiments, to a process for controlling the degradation speed of the plastic products prepared with agave fiber and residues treated according to the instant invention.

According to some embodiments, the present disclosure relates to manufacture of biodegradable plastic products based on a mixture made of agave fibers and residues.

The present disclosure relates, in some embodiments, to supplying a mixture of polymers, fibers and treated agave residues and oxo-degradation additives producing an unexpected synergic effect on the biodegradability and conservation of the mechanical properties in compound material formulations used in manufacturing plastic articles.

According to some embodiments, the present disclosure relates to using treated agave fiber not only in its traditional reinforcing function of improving mechanical properties, as several patents of the state of the art claim, but also as a contribution to the control of the degradation speed leading thus to a reduction in the use of oil-derived polyolefins.

The present disclosure relates, in some embodiments, to supplying a versatile process in which additives commonly used in the state of the art are employed, such as non-slip additives, reinforcement enhancers, antiblocking agents, colorants and pigments.

According to some embodiments, the present disclosure relates to biodegradable products prepared based on the process of the instant invention.

The present disclosure relates, in some embodiments, to a process for preparing a thermoplastic polymer mixture based on agave fiber, residues and oxo-degradation additives. A method may comprise, for example, reducing the fiber size through wet treatment of the fiber wherein the raw fiber is suspended in water at a fiber concentration ranging from 1 to 70% (e.g., preferably from 10 to 40%) or reducing the fiber size through dry fiber treatment in absence of water. Reduced fiber sizes may range from about 1 to about 100 micrometers and may be prepared using, for example, ball mills, hammer mills, jaw mills, roller mills, sand mills, vibratory mills and other methods appropriate for wet and dry processes. In some embodiments, wet size reduction is preferred. Raw fiber may be subjected to a water washing process through which the concentration of all soluble substances, mainly reducing sugars and large particle suspensions, agglomerate and fiber foreign sediments are reduced or totally removed. Washing may be performed in stirred tanks at an agave fiber concentration ranging from about 1 to about 70% (e.g., preferably from 10 to 40%) and/or require replacement of the water in which the fibers are suspended through filtration or other known separation processes. Several water replacements can be required to reach a fiber sugar concentration lower than 10%, preferably lower than 5% and most preferably lower than 1%. Sugar free fiber may pass to a drying process which can be conducted through any conventional method such as solar drying, batch drying in trays, forced circulation ovens, direct heat, infrared radiation, vacuum drying, rotary continuous driers, continuous drying tunnels and other drying processes. Residual humidity, in some embodiments, should be lower than 10%, preferably lower than 5%. Fibers and/or a sugar free fiber suspension may pass to a size classification process, in some embodiments. A size classification process can be conducted using any wet or dry route method and permitting the selection of various particle size ranges. According to some embodiments, a fiber fraction having the appropriate size is dried through any conventional method such as solar drying, batch drying in trays, forced circulation ovens, direct heat, infrared radiation, vacuum drying, rotary continuous driers, continuous drying tunnels and others. A fiber fraction not having the appropriate size is re-circulated to the initial size reduction process, through a dry or wet fiber treatment.

In some embodiments, dry fiber treatment comprises (a) receiving the raw fiber from agave bagasse as obtained from the tequila manufacturing process, (b) passing the fiber through a knife mill (e.g., Brabender trademark) in a continuous feeding process obtaining agave fibers averaging 3 mm, (c) milling the obtained material in a ball mill (e.g., Fritsch trademark, model Pulverisette 6) at 350 rpm, during a 15-minute period, (d) obtaining a powder having a size averaging 15 micrometers, (e) washing the particles obtained in the previous step in a 40% particle and 60% water ratio, (f) heating the mixture at boiling point during 15 minutes, (g) passing then the mixture through a vacuum filtration funnel obtaining a paste having a sugar content lower than 0.5%, (h) placing said paste in a container into which 5% stearic acid diluted in warm water, based on the dry mass of the agave fiber, is added, (i) shaking during 10 minutes and passing again through the vacuum filtration funnel, and/or (j) drying the obtained treated agave fiber during 3 hours in a forced circulation oven at 80 degrees centigrade obtaining a powder having a flour consistency.

Wet fiber treatment may comprise, according to some embodiments, (a) receiving the raw fiber from agave bagasse, (b) passing the fiber through a knife mill (e.g., Brabender trademark) to reduce its size at a 3 mm average, (c) suspending the agave fiber in sufficient water to be subjected to wet milling in a stirred ball mill (e.g., “Wet Grinding Attritor” of Union Process, model 01), (d) processing 500 grams of the fiber suspension in the mill during 30 minutes to obtain particles averaging 15 micrometers, (e) passing the suspension obtained to a vacuum filtration and washing process in a kitasato flask and paper filter, (f) recovering the wet and washed agave fiber having a sugar contents lower than 0.5%, (g) passing the paste obtained through a planetary mixer Kitchen Aid® while heating the container for drying purposes.

In some embodiments, a method may further comprise, upon obtaining 500 g of dry base fiber, adding 5% stearic acid in flakes and mixing during 1 hour at 70° C. to obtain the sugar-free fiber having the appropriate size, and with surface treatment for efficient incorporation into a thermoplastic material for preparing the fiber plastic concentrate. A method may also include a surface treatment of the agave fiber particles. For example, a surface treatment may be conducted in a planetary mixer for dry solids, in which the size classified sugar-free fibers are placed, to which the coupling agent(s) is (are) added for surface conditioning purposes.

In some embodiments, a coupling agent may comprise from about 0.5% to about 8% by mass of agave fibers depending on the thermoplastic polymer to be processed to make it biodegradable. Coupling agents may be incorporated, for example, in one or two steps. A two-step process may include pretreating fiber with a coupling agent followed by high temperature mixing (e.g., preferably in a twin screw extruder) with the thermoplastic polymer in order to obtain a thermoplastic polymer mixture known as Masterbatch (MB) ready to be used for manufacturing various objects when combined and processed with various thermoplastic polymers. In a one-step process, all the components of the mixture, agave fiber, coupling agent and thermoplastic polymer are simultaneously mixed before being fed to an extruder for obtaining a masterbatch. Examples of coupling agents include, in some embodiments, organic agents (e.g., isocyanates, anhydrates, amides, imides, acrylates, chlorotriazines, epoxic, organic acids, monomers, polymers and copolymers), inorganic agents (e.g., silicates) and inorganic-organic agents (e.g., sylanes wherein the preferred sylane is Silquest® A-172 A-174 and the titanates). In some embodiments, coupling agents may include binding agents (e.g., modified thermoplastic polymers such as polypropylene with maleic anhydride, styrene-ethylene-butylene-styrene maleate, styrene-maleic anhydride), compatibilizers (e.g., acetic anhydride, methyl isocyanate and maleic anhydride), dispersing agents (e.g., stearic acid and calcium, magnesium and zinc stearates, preferably stearates and sylanes alone or in binary combination, estaric acid and calcium stearate being preferred) and/or surfactants. In some embodiments, a thermoplastic polymer can be one single polyolefin or mixture of two or more polyolefins. A polyolefin may comprise, for example, polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof are also included. Polypropylene (PP), Low Density Polyethylene (LDPE), and High Density Polyethylene (HDPE) may be particularly preferred in some embodiments. A polyolefin, according to some embodiments, may include a recycled polyolefin. A process may include an oxo-degradation additive comprising, according to some embodiments, a compound with a combination of metallic carboxylate and an aliphatic poly hydroxy carboxylic acid (e.g., Envirocare®, Addiflex®, TDPA® and Celspan®, Celspan® being particularly preferred).

The present disclosure relates, in some embodiments, to a thermoplastic mixture based on agave fibers and residues and oxo-degradation additives obtained from a process of the disclosure including, for example, (a) preparing an extruder mixer (e.g., Werner & Pfleiderer model ZK30), (b) stabilizing the temperature level in a range from 110° to 130° centigrade, (c) obtaining two different mixtures, (d) in the first one mixing the treated and milled agave fiber from the dry fiber treatment); (e) providing an oxo-degradation additive and a LDPE polymer resin; in the second mixture, (f) mixing only the agave fiber treated with LDPE resin, (g) loading the materials to be mixed in the dosifier of the mixing machine, (h) programming the dosification (e.g., programming the dosification with the following conditions: in the first mixture (“Master 1”) 40% of milled and treated agave fiber; 1% of oxo-degradation additive Celspan 481® obtained at Phoenix Plastics; and 59% LDPE; and in the second mixture (“Master 2”): 40% of milled and treated agave fiber and 60% LDPE); (i) feeding the mixtures to a counter-rotating twin screw extruder reaching a most homogeneous fused mixing at a pressure of 28.83/30.23 Kg/cm3 (410/430 pounds/square inch); screw stress at 59/63% torque; and a rotation speed of 250 rpm; (j) obtaining the homogeneous mixture in the shape of filaments that are cooled in two cold air stations; (k) passing through a cutting machine, from which the agave fiber concentrated thermoplastic compound is obtained, for example, in the shape of 3 mm-diameter pellets. In some embodiments, a thermoplastic polymer can be a polyolefin or a mixture of two or more polyolefins. A polyolefin may comprise, in some embodiments, a Polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof. Polypropylene (PP), Low Density Polyethylene (LDPE) and High Density Polyethylene (HDPE) may be particularly preferred in some embodiments. A polyolefin, according to some embodiments, may include a recycled polyolefin. A mixture may include an oxo-degradation additive comprising, according to some embodiments, a compound with a combination of metallic carboxylate and an aliphatic poly hydroxy carboxylic acid (e.g., Envirocare®, Addiflex®, TDPA® and Celspan®, Celspan® being particularly preferred).

In some embodiments, the present disclosure relates to a pellet obtained from the thermoplastic polymer mixture based on agave fibers, wherein the pellet comprises agave fibers and residues, an oxo-degradation additive and a thermoplastic polymer. A pellet may be mixed with polyolefins comprising polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers. According to some embodiments, polypropylene, polybutylene, polymethylpentene and mixtures thereof are also included, for making plastic products. A pellet may be mixed, in some embodiments, with polypropylene (PP), Low Density Polyethylene (LDPE), and High Density Polyethylene (HDPE) that are particularly appropriate. A polyolefin, according to some embodiments, may include a recycled polyolefin.

The present disclosure related, according to some embodiments, to a biodegradable plastic article comprising one or more thermoplastic polymers, agave fibers and residues and/or oxo-degradation additives. A biodegradable plastic may include, for example, agave fibers and residues from Weber's Blue Agave. In some embodiments, thermoplastic polymers used can be one single polyolefin or a mixture of two or more polyolefins. In some embodiments, a biodegradable plastic article may include one or more polyolefins comprising polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof. Polypropylene (PP), Low Density Polyethylene (LDPE) and High Density Polyethylene (HDPE) may be particularly preferred in some embodiments. A polyolefin, according to some embodiments, may include a recycled polyolefin. A biodegradable plastic article may include an oxo-degradation additive comprising, according to some embodiments, a compound with a combination of metallic carboxylate and an aliphatic polyhydroxy carboxylic acid (e.g., Envirocare®, Addiflex®, TDPA® and Celspan®, Celspan® being particularly preferred). In some embodiments, a biodegradable plastic article may comprise packaging, bags, plates, glasses, knives, forks, spoons, trays, medical articles such as implants, tube, gloves, toys and the like.

### BRIEF DESCRIPTION OF THE FIGURES

FIG. 1 is a process chart of agave fiber treatment.

FIG. 2 shows the elongation loss ratio at different times in the photo-degradation test in the accelerated aging chamber.

FIG. 3 shows the elongation retention percentage at 9 and 12 days in the photo-degradation test in the accelerated aging chamber.

FIG. 4 shows the films maximum stress versus time, with several formulations in the photo-degradation test in the accelerated aging chamber.

### DETAILED DESCRIPTION OF THE INVENTION

The instant invention relates to the plastic industry and more particularly to the biodegradable plastic industry and consists of a process for preparing a mixture comprising: thermoplastic polymers; Weber's Blue Agave (agave) fibers and residues; oxo-degradation agents as well as other additives for preparing biodegradable plastics.

In the context of the instant invention “biodegradable” refers to any material losing its integrity and physical chemical properties through the action of environmental action such as solar radiation, humidity, temperature, erosion and pressure, and through the action of biological agents such as plants, animals and microorganisms (bacteria and molds).

The technical problem solved by the instant invention is the reuse of residual materials from industrial processes (for instance, from the tequila making process) and on the other hand, the elaboration of biodegradable products having multiple uses and widespread demand. The elaboration of said products contributes to the prevention of the accumulation of materials showing low or null degradability when exposed to the environment, such as plastics, and to the generation of biodegradable products from the above-mentioned materials.

Surprisingly it has been evidenced that the mixture of blue agave residual fibers from the tequila manufacturing process with polyolefin-based thermoplastic polymers derived from hydrocarbons and oxo-degradation additives results in compounds having adequate properties for elaborating solid products showing better degradation characteristics than the ones obtained through the use of binary mixtures of the mentioned substances. Because of this, the design of a process for conditioning said fibers was made in order to incorporate them to a mixture of polymers and oxo-degradation additives, obtaining thus a Masterbatch (MB) for manufacturing biodegradable plastic articles.

The mixture consists of hydrocarbon-derived thermoplastic polymers serving as a binding matrix for the compound material, in which the other components are dispersed. A compound material refers to a material with defined uniform properties resulting from the heterogeneous mixture of polymers and other components. The thermoplastics used in the instant invention can be one single polyolefin or a mixture of two or more polyolefins.

The polyolefins useful in the instant invention comprise, for example, and not limitingly: Polyethylene (PE), of the types known as Low Density Polyethylene (LDPE), High Density Polyethylene (HDPE), Ultra-High Molecular Weight Polyethylene (UHMWPE), and copolymers of ethylene with another monomer, for example: ethylene-propylene copolymers. Polypropylene, polybutylene, polymethylpentene and mixtures thereof are also included. Polypropylene (PP), Low Density Polyethylene (LDPE) and High Density Polyethylene (HDPE), are particularly preferred for the objects of the instant invention. Moreover, it is important to stress that recycled polyolefins selected from the above mentioned ones can also be outstandingly used in this invention.

Because agave fiber is a naturally biodegradable material, its incorporation to a polymeric compounds formulation requires its exposition to biological environmental factors so that it can be used as food by various microorganisms; thus its use in combination with thermoplastics will require the primary degradation of the latter. According to the instant invention, unexpected synergic effect has been found with regard to biodegradability and conservation of the mechanical properties when the following elements are combined: thermoplastic polymers; oxo-degradation additives as well as agave fibers and residues in compound materials formulations used in the manufacture of plastic articles and utensils. The oxo-degradation additive has a double function: first, to break the thermoplastic polymer chains to adequate sizes for serving as source of food for microorganisms; and second, to expose the agave fibers treated as described in the instant invention to the degradation action of microorganisms, accelerating in this way their decomposition and incorporation to the natural environment. Typically, the agave fiber obtained from the various generation processes consists of 65% cellulose, 5.5% hemicellulose, 17% lignin and 12.5% extractable materials as already mentioned above and will be known hereinafter as “raw fiber”. Said characteristics make it inappropriate for application according to the instant invention and thus must be modified through physical and chemical processes forming an integral part of the instant invention.

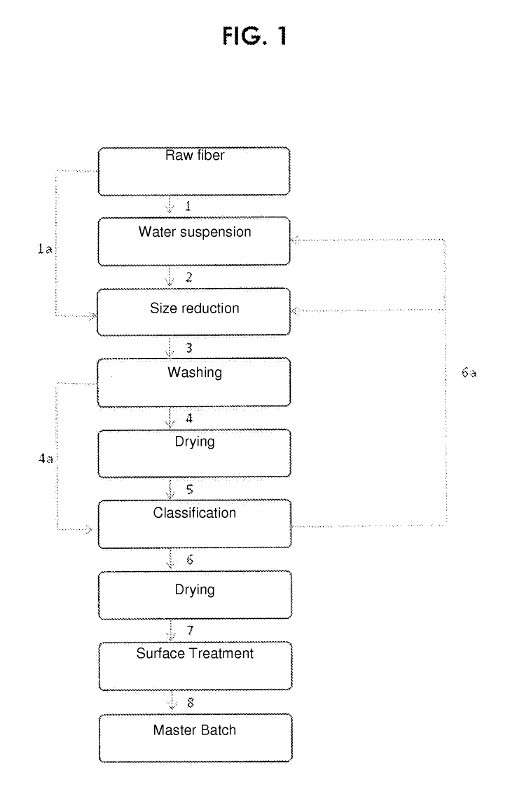

The preferred way of performing the instant invention is described hereinafter in the preferred embodiment. With reference to FIG. 1, the preferred embodiment is presented, illustratively but not limitingly, through a process for preparing a polymeric thermoplastic mixture based on agave fibers and residues that comprises the following stages.

As a first step, it is necessary to reduce the size of the fiber. This can be done through a wet fiber treatment wherein the raw fiber is suspended in water (step 1), in fiber concentration ranging from 1 to 70%, preferably from 10 to 40%. This step can also be performed without water, i.e. through a dry fiber treatment (step 1a). The fiber size is reduced to 1 to 100 micrometers (step 2). For this purpose methods well known in the state of the art can be used such as ball mills, hammer mills, jaw mills, roller mills, sand mills, vibration mills as well as other mills appropriate for wet and dry processes, and widely described in “Perry Manual del Ingeniero Químico”; McGraw-Hill, 6th edition, Volume 1, pages 8.10-8.82, size reduction in wet condition being preferred. Then, the raw fiber is submitted to a water washing process (step 3), through which the concentration of all soluble substances, mainly reducing sugars and large suspended particles, agglomerates and sediments foreign to the useful fibers, are reduced or totally removed. The washing is performed in shaken tanks at a concentration of agave fiber ranging from 1% to 70% —preferably from 10% to 40%—and requiring the replacement of the water in which the fiber is suspended, through filtration or other separation process known in the art, multiple water replacements will eventually be requested to reach a fiber sugar contents 10%, preferably lower than 5%, and especially, lower than 1%. The sugar free fiber is passed to a drying process (step 4), that can be conducted through any conventional method, such as solar drying, batch drying in trays, forced circulation ovens, direct heat, infrared radiation, vacuum drying, rotary continuous driers, continuous drying tunnels and other methods widely described in “Perry, Manual del Ingeniero Químico” Section 20, Desecación de sólidos y sistemas gas-sólido (Desiccation of solids and gas-solid systems). The residual moisture level should be lower than 10%, preferably lower than 5%. Afterwards, the fiber passes to a size classification process (step 5). Alternatively, the sugar free fiber suspension can be send to the classification process (step 4a). The fiber size classification can be conducted using any wet or dry method selected from the ones established in the art and widely described in the above mentioned work “Perry, Manual del Ingeniero Químico” pages 21.14-21.60 and permitting the selection of various particle size ranges. The fiber fraction with the requested size is dried through a conventional method such as: solar drying, batch drying in trays, forced circulation ovens, direct heat, infrared radiation, vacuum drying, rotary continuous driers, continuous drying tunnels and other methods (step 6). The fiber fraction outside the adequate size is re-circulated to the initial size reduction process, in dry or wet condition (step 6a).

The agave fiber cannot be mixed spontaneously with the thermoplastic polymers because it has polar (hydrophilic) characteristics that make it superficially incompatible with the thermoplastics having non polar (hydrophobic) characteristics. Taking the above into account, it is necessary to subject the agave fiber to a superficial treatment (step 7) and thus improve its properties, to reach the purposes of the instant invention. The treatment is conducted in an adequate mixing equipment selected from the ones already known and commonly used in the state of the art, in which the sugar-free fibers having the appropriate size are placed, and to which the necessary additive(s) is (are) added for surface conditioning. The treatment supplies improved wetting properties as well as better incorporation to thermoplastic polymers. It is necessary to use coupling agents that are classified as organic, inorganic and inorganic-organic agents. Among organic agents, isocyanates, anhydrates, amides, imides, acrylates, chlorotriazines, epoxic, organic acids, monomers, polymers and copolymers can be mentioned. Among inorganic agents, silicates are the most appropriate; while the preferred agents for the instant invention among the inorganic-organic agents are silanes and titanates. Functionally, globally speaking, coupling agents comprise moreover binding agents, compatibilizers, dispersing agents, as well as surfactants. The first ones act as molecular “bridges” joining efficiently the polar zones of the fiber to the thermoplastic polymer through one or more of the following mechanisms: covalent link, physical reticulation of the polymer chains and strong secondary interactions such as hydrogen bridges. Examples of this type of binding agents are modified thermoplastic polymers such as polypropylene with maleic anhyhidrate, styrene-ethylene-butylene-styrene maleate and styrene-maleic anhydrate. Dispersing agents reduce the energy between the different phases to improve the mixing and obtain a uniform composition in the resulting compound. Stearic acid and calcium, magnesium, and zinc stearates are typical examples. Compatibilizers are used to supply compatibility among immiscible elements through the interface tension reduction. Within this group of agents, acetic anhydrate, methyl isocyanate and maleic anhydrate can be mentioned, not exhaustively or limitingly. They are all appropriate for the purpose of the instant invention, preferably stearates and sylanes alone or in binary combination. Stearic acid and calcium stearate and, among the sylanes, Silano Silquest® A-172 and A-174 available at Crompton Corporation, OSi Specialties are especially preferred. The coupling agents comprise from 2% to 8% by mass of the agave fibers and depend on the thermoplastic polymer to be processed for making it biodegradable according to the instant invention. The two preferred forms of incorporation of the coupling agents are the two-step process and the one-step process. The two-step process includes the pre-treatment stages of the fibers with the coupling agent as the first step, followed by the mixing with the thermoplastic polymer at high temperature to obtain the polymer thermoplastic masterbatch—known as MB—ready to be used in the manufacturing of various objects when combined and processed with various thermoplastic polymers (step 8). Mixing at high temperature is better conducted in a two screw extruder of the types known in the state of the art. In the one-step process, the components of the mixture, agave fiber, coupling agent and thermoplastic polymer, are mixed together before being fed to the extruder for obtaining the masterbatch (MB).

### EXAMPLES

The following examples of embodiments of the instant invention will be clearly understandable for a person with average knowledge of the art to which it belongs and their purpose is to demonstrate but not limit the various forms in which the instant invention can be embodied.

### Example 1

### Dry Fiber Treatment

The agave bagasse raw fiber was received as obtained from the tequila manufacturing process. It was passed through a knife mill (Brabender trademark) in a continuous feed process obtaining an agave fiber averaging 3 mm. The obtained material was milled in a ball mill (Fritsch trademark model Pulverisette 6) at 350 rpm, during 15 minutes obtaining a powder averaging 15 micrometers. The size was evaluated in an optical microscope equipped with an image analyzer. The particles obtained in the above process were washed in a 40% particle and 60% water ratio. This mixture was subjected to boiling during 15 minutes. It was then passed through a vacuum filtration funnel obtaining a paste having a sugar content below 0.5%.

Said paste was placed in a container into which 5% stearic acid diluted in warm water, based on the dry mass of the agave fiber, was added. It was stirred within 10 minutes and passed again through the vacuum filtration funnel. The agave fiber treated in this way was dried during 3 hours in a forced circulation oven at 80 degrees C. obtaining a powder having flour consistency.

### Example 2

### Wet Fiber Treatment

The agave bagasse raw fiber was received and passed through a knife mill (Brabender trademark) in order to reduce its size to 3 mm average. The agave fiber of this first step was suspended in sufficient water to be wet milled in a stirred ball mill “Wet Grinding Attritor” of Union Process, model 01. 500 grams of the fiber suspension were processed in the mill during 30 minutes to obtain particles averaging 15 micrometers. The obtained suspension was passed to a vacuum filtration and washing process in a kitasato flask and paper filter. The wet agave fiber was recovered and washed having a sugar contents lower than 0.5%.

The obtained paste was sent to a planetary mixer Kitchen Aid® with while the container was heated for drying purposes. At 500 g of fiber, dry base, 5% stearic acid in flakes was added and it was mixed during 1 hour at 70° C. to obtain a sugar-free fiber of the appropriate size, submitted to surface treatment for efficient incorporation into a thermoplastic material in order to prepare the fiber plastic concentrate.

### Example 3

### Masterbatch (MB) Preparation (Thermoplastic Polymer Mixture)

A Werner & Pfleiderer mixer/extruder, model ZK30, was prepared, stabilizing the temperature within a range from 110° to 130° C.

Two different mixtures were prepared: In the first mixture, the following ingredients were mixed: the treated and milled agave fiber from example 1; an oxo-degradation additive and a LDPE resin. In the second mixture, only the agave fiber treated with LDPE resin was mixed. The materials to be mixed were loaded in the mixer dosing unit. It was programmed to satisfy the following dosing conditions: first formulation: 40% milled and treated agave fiber; 1% oxo-degradation additive Celspan 481® obtained at Phoenix Plastics; and 59% LDPE; second formulation: 40% milled and treated agave fiber and 60% LDPE. Hereinafter, the first formulation is known as Master 1 and the second formulation as Master 2.

Said elements were introduced into the counter rotating twin screw extruder obtaining a most homogeneous fused mixing. The processing data were: Pressure 28.83/30.23 Kg/cm³ (410/430 pounds/square inch); screw stress at 59/63% torque; and rotation speed: 250 rpm.

The homogeneous mixture of the materials exited the extruder in the form of filaments that were cooled in two cold air stations. From there they were sent to a cutting machine, from which the agave fiber concentrated thermoplastic compound was obtained as 3 mm-diameter pellets.

### Example 4

### Blown Film Preparation

In a blowing extruder BETOL with the following operation condition: temperature ranging from 115° to 140° centigrade; screw diameter: 32 mm; blowing ratio: 2.45; average thickness: 2 mils. Four films were made with different formulations:

1) A manual mixture comprising 10% “master 1” and 90% LDPE PX20020X; it was fed to the blowing extruder and the result was a bi-oriented film having a particle uniform distribution aspect in the film. It is known hereinafter as “P-A-O Sample”.

2) A manual mixture comprising 10% “Master 2” and 90% LDPE PX20020X; it was fed to the blowing extruder and the result was a bi-oriented film having a particle uniform distribution aspect in the film. It is known hereinafter as “P-A Sample”.

3) 100% LDPE PX20020X was fed to the blowing extruder. The result was a transparent bi-oriented film, known hereinafter as “P Sample”.

4) Finally, a manual mixture was made comprising 99% LDPE PX20020X and 1% oxo-degradation additive Celspan 481® from Phoenix Plastics, obtaining a bi-oriented film known hereinafter as “P-O Sample”.

### Example 5

### Injected Piece Preparation

25% “Master 1” and 75% PX65050 HDPE resin were mixed manually in a Fu Chun Shin machine model HT150. The mixture passed through the injecting device at a temperature ranging from 160° to 180° centigrade, using an alternative screw that transported it and fused it injecting a standard test tube. The piece was extracted from the mold without any problem and a smooth surface finishing was obtained.

### Example 6

### Photo-Degradation Tests in the Accelerated Aging Chamber

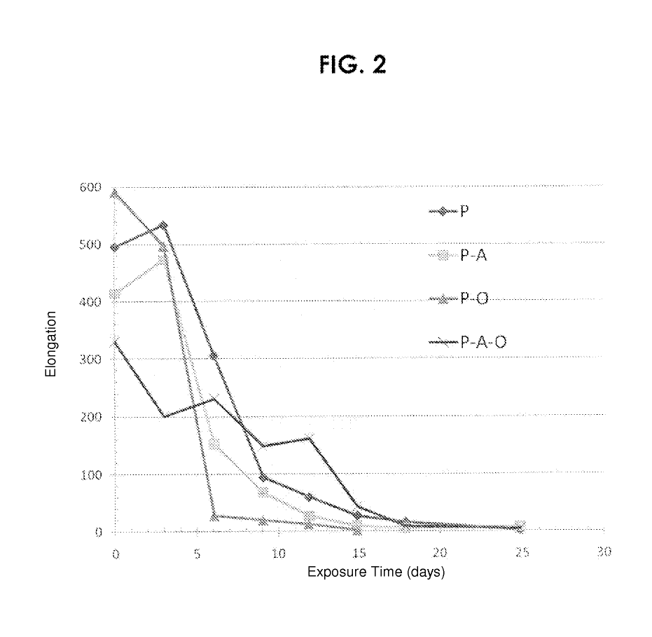

The samples of the films to be analyzed were placed in an accelerated aging chamber (QUV Panel Test trademark). All the specifications mentioned in ASTM D 5802-01 standard were followed. The continuously working chamber was set at 20 hours of radiation and 4 hours of condensation on a daily basis. During the radiation hours, the samples were exposed at a temperature of 60° centigrade and during the condensation hours they were exposed at 40° centigrade. The machine is equipped with 4 mercury lamps emitting UV at a wavelength ranging from 440 to 480 nanometers. in the chamber 6 sets of the following samples were placed “P-A-O Sample”; “P-A Sample”; “P Sample”; and “P-O Sample”. Every 3 days a sample was extracted to analyze its mechanical properties. As a result graphs were obtained showing the exposition time versus the loss of property, as shown in FIGS. 2, 3 and 4. The standard establishes that when the sample reaches 50% of its property it has lost its mechanical properties. In this example, we took the samples down to 0% property in order to measure their biodegradability in a future test. In the following table the results elongation retention versus photo-degradation time in the accelerated aging chamber are shown. It can be seen that the formula with oxo-degradation additive and agave fiber, according to the instant invention, retains better the property than the other samples with the other formulas. The last line of the table marked E50, shows the time elapsed for a 50% loss of the initial value of the property and shows the synergic effect of the combination of the treated agave fiber according to the instant invention and the oxo-degradation additive. This can also be seen in FIG. 2 where it can be clearly observed that the elongation loss is less abrupt in the formula with the binary mixture of agave fiber conditioned according to the invention and the oxo-degradation additive.

TABLE 1
Retention of the elongation property as a percentage of the initial
value in the photo degradation test in the accelerated aging chamber.

| | P | P-A | P-O | P-A-O |
|---|---|---|---|---|
| Initial | 100 | 100 | 100 | 100 |
| 9 days | 19 | 16 | 3 | 45 |
| 12 days | 12 | 6 | 2 | 45 |
| E50, days | 7 | 5 to 6 | 4 to 5 | 9 |

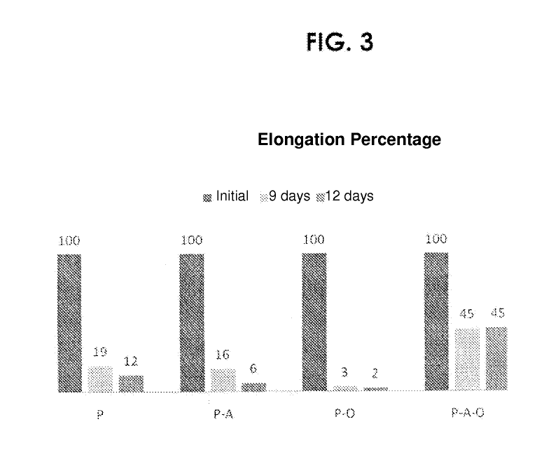

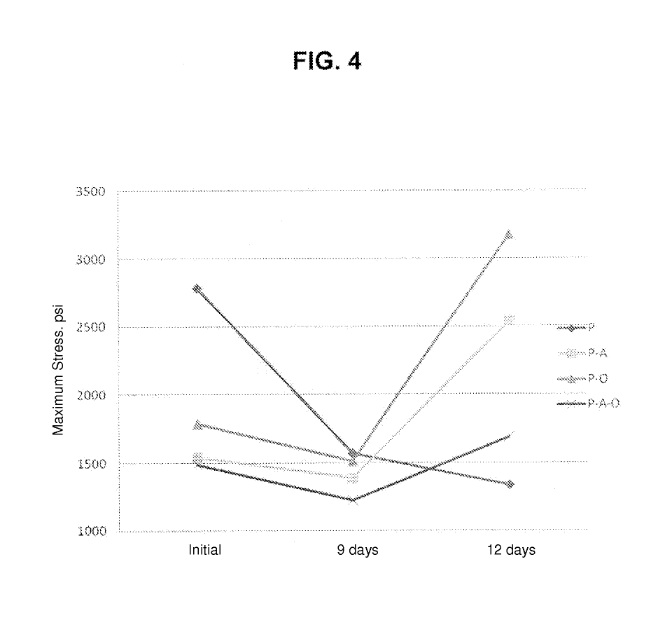

FIG. 3 shows these results graphically and the considerable performance advantage of the agave fiber mixture according to the instant invention and the oxo-degradation additive can be seen. Moreover, FIG. 4 shows the behavior of the maximum stress property of the test films. It can be seen that the P-A-O sample conserves better the property versus the exposure time to the physical degrading factors. The incorporation of the agave fiber with the oxo-degradation additive has a residual reinforcement effect at prolonged exposition times equivalent to periods when the elongation property has been lost beyond a useful value, except with regard to the combination of agave fiber conditioned according to the instant invention and with the oxo-degradation additive (P-A-O) that keeps its property within a useful range. This demonstrates the unexpected benefit of said binary mixture.

### Example 7

### Biodegradability Test of a Plastic Film

In order to perform this test, the specifications established in ASTM 5247-92 standard were followed. The general objective of this standard is defined as a microbiological test permitting the evaluation of plastic biodegradability under controlled anaerobic conditions.

Change in the physical-mechanical properties of tension and elongation percentage, as well as changes in the molecular weight distribution are taken as a measure of the material degradability. In this determination, the Phanerochaete chrysosporium fungus is used as test organism because of its cellulolytic capacity. In order to perform the test, the fungus spores are inoculated into a defined liquid medium under controlled temperature and stirring conditions. Once the medium is inoculated, the sample to be evaluated is added. As control, test tubes of known materials susceptible to biodegradation by this microorganism are used. The test is conducted during the period of four weeks, making daily inspections of the samples in order to record the presence or absence of fungus development on the surface of the materials under evaluation.

For this test, the films prepared according to example 6 were used after 25 days of exposition under the photo-degradation test conditions and the loss of sample weight due to fungus attack was measured.

| | Weight loss | |
|---|---|---|
| Sample | after 4 weeks; % | Observations |
| P | 2 | Absence of fungus. |
| P-O | 5 | Fungus growth can be seen in certain zones. |
| P-A | 5 | Fungus growth can be seen in the points |
| | | where agave fiber accumulation exists. |
| P-A-O | 50 | Generalized fungus growth is observed. |

During the 4 weeks of exposition, it was evidenced that the P-O-A film is susceptible to attack by Phanerochaete chrysosporium as evaluated according to ASTM D5247 standard.

It will be obvious for a person with knowledge in the art to which the instant invention belongs that this process can be conducted alternatively, through modification in the order or the use of new equipments, to the technique of the mentioned unitary processes, or to their simultaneous performance, in one single multi-purpose process equipment and said changes fall within the spirit of the instant invention.

What is claimed is:

1. A process for preparing a thermoplastic polymer mixture based on agave fiber, residues and oxo-degradation additives, comprising the following steps:
reduction of the fiber size through wet treatment of the fiber wherein the raw fiber is suspended in water at a fiber concentration ranging from 1 to 70%, preferably from 10 to 40% or conducted in absence of water, through dry fiber treatment;
the reduced fiber size ranges from 1 to 100 micrometers using methods such as ball mills, hammer mills, jaw mills, roller mills, sand mills, vibratory mills and other methods appropriate for wet and dry processes, wet size reduction being preferred;
the raw fiber is subjected to a water washing process through which the concentration of all soluble substances, mainly reducing sugars and large particle suspensions, agglomerate and fiber foreign sediments are reduced or totally removed, the washing being made in stirred tanks at a agave fiber concentration ranging from 1 to 70%, preferably from 10 to 40% and requiring the replacement of the water in which the fibers are suspended through filtration or other known separation process, several water replacements can be required to reach a fiber sugar concentration lower than 10%, preferably lower than 5% and most preferably lower than 1%;
the sugar free fiber passes to a drying process which can be conducted through any conventional method such as solar drying, batch drying in trays, forced circulation ovens, direct heat, infrared radiation, vacuum drying, rotary continuous driers, continuous drying tunnels and other drying processes, the residual humidity level should be lower than 10%, preferably lower than 5%;
the fibers passes to a size classification process, said size classification process can be conducted using any wet or dry route method and permitting the selection of various particle size ranges;
alternatively, the sugar free fiber suspension can be sent to the size classification process;
the fiber fraction having the appropriate size is dried through any conventional method such as solar drying, batch drying in trays, forced circulation ovens, direct heat, infrared radiation, vacuum drying, rotary continuous driers, continuous drying tunnels and others; and
the fiber fraction not having the appropriate size is re-circulated to the initial size reduction process, through a dry or wet fiber treatment.

2. The process according to claim 1, wherein the dry fiber treatment comprises the steps of receiving the raw fiber from agave bagasse as obtained from the tequila manufacturing process, passing the fiber through a knife mill (Brabender trademark) in a continuous feeding process obtaining agave fibers averaging 3 mm, milling the obtained material in a ball mill (Fritsch trademark, model Pulverisette 6) at 350 rpm, during a 15-minute period, obtaining a powder having a size averaging 15 micrometers, washing the particles obtained in the previous step in a 40% particle and 60% water ratio, heating the mixture at boiling point during 15 minutes, passing then the mixture through a vacuum filtration funnel obtaining a paste having a sugar content lower than 0.5%, placing said paste in a container into which 5% stearic acid diluted in warm water, based on the dry mass of the agave fiber, is added, shaking during 10 minutes and passing again through the vacuum filtration funnel, drying the obtained treated agave fiber during 3 hours in a forced circulation oven at 80 degrees centigrade obtaining a powder having a flour consistency.

3. The process according to claim 1, wherein the wet fiber treatment comprises the steps of receiving the raw fiber from agave bagasse, passing the fiber through a knife mill (Brabender trademark) to reduce its size at a 3 mm average, suspending the agave fiber in sufficient water to be subjected to wet milling in a stirred ball mill “Wet Grinding Attritor” of Union Process, model 01, processing 500 grams of the fiber suspension in the mill during 30 minutes to obtain particles averaging 15 micrometers, passing the suspension obtained to a vacuum filtration and washing process in a kitasato flask and paper filter, recovering the wet and washed agave fiber having a sugar contents lower than 0.5%, passing the paste obtained through a planetary mixer Kitchen Aid® while heating the container for drying purposes.

4. The process according to claim 1, wherein at 500 g of dry base fiber, 5% stearic acid in flakes is added and it is mixed during 1 hour at 70° C. to obtain the sugar-free fiber having the appropriate size, and with surface treatment for efficient incorporation into a thermoplastic material for preparing the fiber plastic concentrate.

5. The process according to claim 1, wherein the process comprises also a surface treatment of the agave fiber particles, the treatment is conducted in a planetary mixer for dry solids, in which the size classified sugar-free fibers are placed, to which the coupling agent(s) is (are) added for surface conditioning purposes.

6. The process according to claim 1, wherein the coupling agents comprise from 0.5% to 8% by mass of agave fibers depending on the thermoplastic polymer to be processed in order to make it biodegradable and comprises moreover the one-step or two-step incorporation of the coupling agents.

7. The process according to claim 6, wherein the two-step process includes the stages of fiber pre-treatment with the coupling agent as a first step, followed by high temperature mixing with the thermoplastic polymer in order to obtain a thermoplastic polymer mixture known as Masterbatch (MB) ready to be used for manufacturing various objects when combined and processed with various thermoplastic polymers.

8. The process according to claim 7, wherein the high temperature mixing is preferably performed in a twin screw extruder.

9. The process according to claim 6, wherein in the one-step process all the components of the mixture, the agave fiber, the coupling agent and the thermoplastic polymer are simultaneously mixed before being fed to the extruder for obtaining the masterbatch.

10. The process according to claim 5, wherein the coupling agents are selected from the group comprising organic agents, inorganic agents and inorganic-organic agents.

11. The process according to claim 10, wherein the organic coupling agents are selected from the group consisting of isocyanates, anhydrates, amides, imides, acrylates, chlorotriazines, epoxic, organic acids, monomers, polymers and copolymers.

12. The process according to claim 10, wherein the inorganic coupling agents are selected from the group comprising silicates.

13. The process according to claim 10, wherein the inorganic-organic coupling agents are selected from the group consisting of sylanes wherein the preferred sylane is Silquest® A-172 A-174 and the titanates.

14. The process according to claim 5, wherein the coupling agents further comprise binding agents, compatibilizers, dispersing agents and surfactants.

15. The process according to claim 14, wherein the binding agents are selected from the group consisting of modified thermoplastic polymers such as polypropylene with maleic anhydride, styrene-ethylene-butylene-styrene maleate, styrene-maleic anhydride.

16. The process according to claim 14, wherein the compatibilizers are selected from the group consisting of acetic anhydride, methyl isocyanate and maleic anhydride.

17. The process according to claim 14, wherein the dispersing agents are selected from the group consisting of stearic acid and calcium, magnesium and zinc stearates, preferably stearates and sylanes alone or in binary combination, estaric acid and calcium stearate being preferred.

18. The process according to any of claim 9, wherein the thermoplastic polymers used can be one single polyolefin or mixture of two or more polyolefins.

19. The process according to claim 18, wherein the polyolefins comprise polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof are also included.

20. The process according to claim 19, wherein the polypropylene (PP), Low Density Polyethylene (LDPE), and High Density Polyethylene (HDPE) are particularly preferred.

21. The process according to claim 19, wherein recycled polyolefin can also be used.

22. The process according to claim 1, wherein the selected oxo-degradation additive comprises a compound with a combination of one metallic carboxylate and an aliphatic poly hydroxy carboxylic acid (that can be Envirocare®, Addiflex®, TDPA® and Celspan®, Celspan® being particularly preferred).

23. Thermoplastic polymer mixture based on agave fibers and residues and oxo-degradation additives obtained from the process according to claim 1, characterized because it comprises the steps of preparing an extruder mixer Werner & Pfleiderer model ZK30, stabilizing the temperature level in a range from 110° to 130° centigrade, obtaining two different mixtures, in the first one mixing the treated and milled agave fiber from the dry fiber treatment; an oxo-degradation additive and a LDPE polymer resin; in the second mixture, mixing only the agave fiber treated with LDPE resin, loading the materials to be mixed in the dosifier of the mixing machine, programming the dosification with the following conditions: in the first mixture (“Master 1”) 40% of milled and treated agave fiber; 1% of oxo-degradation additive Celspan 481® obtained at Phoenix Plastics; and 59% LDPE; and in the second mixture (“Master 2”): 40% of milled and treated agave fiber and 60% LDPE; said mixtures are fed to a counter-rotating twin screw extruder reaching a most homogeneous fused mixing at a pressure of 28.83/30.23 Kg/cm3 (410/430 pounds/square inch); screw stress at 59/63% torque; and a rotation speed of 250 rpm; the homogeneous mixture is obtained in the shape of filaments that are cooled in two cold air stations; passing through a cutting machine, from which the agave fiber concentrated thermoplastic compound is obtained in the shape of 3 mm-diameter pellets.

24. The mixture according to claim 23, wherein the thermoplastic polymers used can be a polyolefin or a mixture of two or more polyolefins.

25. The mixture according to claim 24, wherein the polyolefins comprise Polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof are also included.

26. The mixture according to claim 25, wherein the polypropylene (PP), Low Density Polyethylene (LDPE) and High Density Polyethylene (HDPE) are particularly preferred.

27. The mixture according to claim 25, wherein recycled polyolefins can also be used.

28. The mixture according to claim 23, wherein the oxo-degradation additive being a compound with a combination of metallic carboxylate and an aliphatic polyhydroxy carboxylic acid is selected from the group consisting of (Envirocare®, Addiflex®, TDPA® and Celspan®, Celspan® being particularly preferred).

29. A pellet obtained from the thermoplastic polymer mixture based on agave fibers and residues according to claim 23, wherein the pellet comprises agave fibers and residues, an oxo-degradation additive and a thermoplastic polymer.

30. The pellet according to claim 29, wherein said pellet is mixed with polyolefins comprising polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof are also included, for making plastic products.

31. The pellet according to claim 30, wherein said pellet is mixed with polypropylene (PP), Low Density Polyethylene (LDPE), and High Density Polyethylene (HDPE) that are particularly appropriate.

32. The pellet according to claim 30, wherein said pellet is mixed with recycled polyolefins.

33. A biodegradable plastic article characterized because it comprises thermoplastic polymers, agave fibers and residues and oxo-degradation additives.

34. The biodegradable plastic article according to claim 33, wherein the agave fibers and residues are from Weber's Blue Agave.

35. The biodegradable plastic article according to claim 33, wherein the thermoplastic polymers used can be one single polyolefin or a mixture of two or more polyolefins.

36. The biodegradable plastic article according to claim 35, wherein the polyolefins comprise polyethylene (PE) selected from the group consisting of Low Density Polyethylene (LDPE), High Density Polyethylene (HDPE), Ultra-High Molecular Weight Polyethylene (UHMWPE), copolymers of ethylene with another monomer as ethylene-propylene copolymers; polypropylene, polybutylene, polymethylpentene and mixtures thereof are also included.

37. The biodegradable plastic article according to claim 35, wherein polypropylene (PP), Low Density Polyethylene (LDPE), and High Density Polyethylene (HDPE) are particularly preferred.

38. The biodegradable plastic article according to claim 35, wherein recycled polyolefins can also be used.

39. The biodegradable plastic article according to claim 33, wherein the oxo-degradation additive being a compound with a combination of metallic carboxylate and an aliphatic polyhydroxy carboxylic acid is selected from the group consisting of (Envirocare®, Addiflex®, TDPA® and Celspan®, Celspan® being particularly preferred).

40. The biodegradable plastic article according to claim 33, characterized because said article is selected from the group consisting of packaging, bags, plates, glasses, knives, forks, spoons, trays, medical articles such as implants, tube, gloves, toys and the like.
